(19) United States
(12) Patent Application Publication
(10) Pub. No.: US 2026/0310933 A1
(43) Pub. Date: Oct. 8, 2026

(54) AI-POWERED ADAPTIVE DATASET TRANSFORMATION

(71) Applicant: Fujitsu Limited, Kawasaki-shi (JP)

(72) Inventors: Aakar GUPTA, Redmond, WA (US); Adil RAHMAN, Charlottesville, VA (US); Koichiro NIINUMA, Pittsburgh, PA (US)

(73) Assignee: Fujitsu Limited, Kawasaki-shi (JP)

(21) Appl. No.: 19/172,275

(22) Filed: Apr. 7, 2025

(51) Int. Cl. G06N 3/045

(52) U.S. Cl. CPC G06N 3/045

(57) ABSTRACT

A method may include receiving a specification dataset and a source dataset and providing, for each of multiple fields in the datasets to a LLM. The method may also include prompting the LLM to analyze field names and metadata to generate and provide semantic information including data descriptions corresponding to data in fields of the specification dataset and data descriptions corresponding to data in fields of the source dataset and providing the semantic information to an interface. The method may further include updating the semantic information by directly updating the semantic information based on the user input and/or prompting the LLM to update the semantic information based on the user input and prompting the LLM, based on the semantic information and user input received, to generate steps and step descriptions for converting portions of the source dataset to converted data having a structure and a format of the specification dataset.

### FIELD

The present disclosure generally relates to dataset transformations using artificial intelligence (AI).

### BACKGROUND

Data integration and transformation processes typically involve combining data from multiple sources and converting it into a unified format. These processes may be used in various applications such as business intelligence, data warehousing, and analytics. Data integration and transformation present challenges when dealing with diverse data structures, formats, and semantics across different source systems.

The subject matter claimed in the present disclosure is not limited to embodiments that solve any disadvantages or that operate only in environments such as those described above. Rather, this background is only provided to illustrate example technology areas where some embodiments described in the present disclosure may be practiced.

### SUMMARY

A method including receiving a specification dataset and a source dataset and providing, for each of multiple fields in the specification dataset and the source dataset, a field name and determined metadata, including sample data, to a computerized large language model (LLM). The method may also include prompting the LLM to analyze field names and the determined metadata to generate and provide semantic information including data descriptions corresponding to data in fields of the specification dataset and data descriptions corresponding to data in fields of the source dataset and providing the semantic information to a user interface. The method may further include in response to user input received via the user interface, updating the semantic information by one or more of: directly updating the semantic information based on the user input and prompting the LLM to update the semantic information based on the user input and prompting the LLM, based on the semantic information and user input received, to generate steps and corresponding step descriptions for converting one or more portions of the source dataset to converted data having a structure and a format of the specification dataset.

The objects and advantages of the embodiments will be realized and achieved at least by the elements, features, and combinations particularly pointed out in the claims. It is to be understood that both the foregoing general description and the following detailed description are explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 is a system diagram illustrating a computerized system for converting source data to target data in accordance with an embodiment of the present disclosure.

FIG. 2 is a flowchart illustrating a processing flow executed for each dataset by the dataset analyzer of FIG. 1, in accordance with one embodiment of the present disclosure.

FIG. 3 is a flowchart illustrating a processing flow executable by the pipeline builder of FIG. 1, in accordance with an embodiment of the present disclosure.

FIG. 4 is a flowchart illustrating a processing flow executable by the code generator of FIG. 1, in accordance with an embodiment of the present disclosure.

FIG. 5 is a flowchart illustrating a processing flow executable by the data converter of FIG. 1, in accordance with an embodiment of the present disclosure.

FIG. 6 illustrates a block diagram of an example computing system in accordance with some embodiments.

### DETAILED DESCRIPTION

Traditional approaches to data integration and transformation typically rely on manual mapping of data fields between source and target systems. This process may be time-consuming and error-prone, especially when dealing with complex data structures or large numbers of fields. Rule-based systems may be used to automate some aspects of data mapping, but may struggle with ambiguous field names or semantic differences between systems.

Data wrangling is a time-consuming task, often consuming up to 80% of an analyst's time. (See Steve Lohr, “For big-data scientists, ‘janitor work’ is key hurdle to insights” New York Times 17 (2014), B4). In response to this challenge, researchers have developed tools to try to streamline data wrangling tasks. For instance, Wrangler, and its extension, Proactive Wrangler, employ programming-by-demonstration techniques to allow users to interactively specify data transformation scripts through a visual interface. (Regarding Wrangler, see Kandel et al., 2011, “Wrangler: interactive visual specification of data transformation scripts,” in Proceedings of the SIGCHI Conference on Human Factors in Computing Systems. ACM, Vancouver BC Canada, 3363-3372, https://doi.org/10.1145/1978942.1979444. Regarding Proactive Wrangler, see Guo et al., 2011, “Proactive wrangling: Mixed-initiative end-user programming of data transformation scripts,” in Proceedings of the 24th annual ACM symposium on User interface software and technology, 65-74).

These systems suggest contextually relevant transformations and provide previews of transformation effects. However, while reducing the need for writing manual code, they still require users to perform the transformations themselves.

Programming-by-example systems have shown promise for data wrangling. Foofah and ProgFromEx synthesize table transformation programs using input-output pairs as examples. Regarding Foofah, see, Jin et al., “Foofah: Transforming Data By Example,” in Proceedings of the 2017 ACM International Conference on Management of Data (SIGMOD '17), Association for Computing Machinery, New York, NY, USA, 683-698, https://doi.org/10.1145/3035918.3064034. Regarding ProgFromEx, see Harris and Gulwani, 2011, “Spreadsheet table transformations from examples,” ACM SIGPLAN Notices 46, 6 (2011), 317-328.

Companies has tried to integrate programming-by-example systems into programs, such as spreadsheets, starting with FlashFill. See Gulwani, “Automating string processing in spreadsheets using input-output examples,” ACM Sigplan Notices 46, 1 (2011), 317-330). However, these systems often struggle with complex, multi-step transformations and may produce overly specific programs that fail to generalize well, especially when provided with limited or non-representative examples.

Natural language-based interfaces have been used for data wrangling tasks. NL2Rigel allows users to extract derivative entities from relational data using natural language. See Huang et al., “Interactive table synthesis with natural language,” IEEE Transactions on Visualization and Computer Graphics (2023). Similarly, WaitGPT leverages conversational LLMs for data analysis and visualization. See, Xie et al., “WaitGPT: Monitoring and Steering Conversational LLM Agent in Data Analysis with On-the-Fly Code Visualization,” arXiv preprint arXiv:2408.01703 (2024)). However, to effectively leverage these systems, users need to be able to communicate their transformation requirements in natural language, which can be challenging for complex transformations or when users lack clarity on the problem or the vocabulary to precisely describe their intentions. Moreover, these systems may struggle with ambiguous or imprecise descriptions, potentially leading to incorrect or unexpected transformations.

Embodiments of the present disclosure address these limitations by leveraging analysis of semantic relationships and a human-in-the-loop approach to manage data conversions more effectively. By integrating AI-driven techniques with human oversight, embodiments of the present disclosure aim to streamline the conversion process while maintaining accuracy and flexibility. One embodiment of the present disclosure utilizes large language models (LLMs) to analyze dataset semantics, generate data descriptions, and propose transformation steps.

Embodiments of the present disclosure relate to data processing systems and associated processing methods to facilitate the transformation of datasets from a source structure and format into a specified target structure and format using a series of computer-executed steps generated by a first computerized large language model (LLM) and/or calls to second LLM to directly convert portions of the source data. Some embodiments are particularly adept at handling complex data transformations that require semantic understanding and integration of data from diverse sources.

These and other aspects of embodiments of the present disclosure are more fully described below. It is to be understood that both the foregoing general description and the following detailed description are explanatory and are not restrictive of the invention, as claimed.

Embodiments of the present disclosure transform (i.e., convert) source data into data having a structure and format of a target (“specification”) dataset. This transformation is implemented through a series of automated and semi-automated steps facilitated by advanced computational models, such as large language models (LLMs). The process begins by loading and analyzing the source dataset and the specification dataset to understand their structure and semantics. This analysis involves identifying, with respect to both datasets, each data field's data type, format, and semantics.

After the initial analysis is complete, a transformation pipeline is generated for to converting source data to data having a structure and a format of the specification dataset. This pipeline comprises a sequence of data transformation steps designed to methodically convert data from the source dataset into the structure and format of the specification dataset. Steps in the pipeline are generated based on semantic understanding of the data fields involved, ensuring that the transformations preserve the meaning and integrity of the data.

During the transformation process, embodiments of the present disclosure may identify fields in the source dataset that require additional information or clarification to accurately map to the specification dataset. In such instances, the system employs a human-in-the-loop approach, prompting the user to provide the necessary information through a user interface. This interactive process allows for dynamic refinement of the transformation steps based on user input, enhancing the accuracy and reliability of the output.

The final stage of the process involves executing the transformation pipeline to convert the source dataset into the desired structure and format. Some embodiments also provide mechanisms for error handling and data validation, ensuring that any issues encountered during the transformation process are promptly addressed and corrected.

By automating the data transformation process and integrating user inputs when necessary, embodiments of the present disclosure reduce the time and effort required to convert datasets into a specified format. This capability is particularly beneficial in environments where data from multiple sources must be integrated and analyzed consistently, such as in data analytics, business intelligence, and scientific research applications.

Embodiments of the disclosure represent tools for data transformation that combine advanced computational techniques with user-friendly interfaces to facilitate the efficient and accurate conversion of diverse data sources into a unified format. This system not only enhances data usability and integrity but also streamlines workflows in data-driven environments, thereby providing substantial value to users and organizations dealing with large and complex datasets.

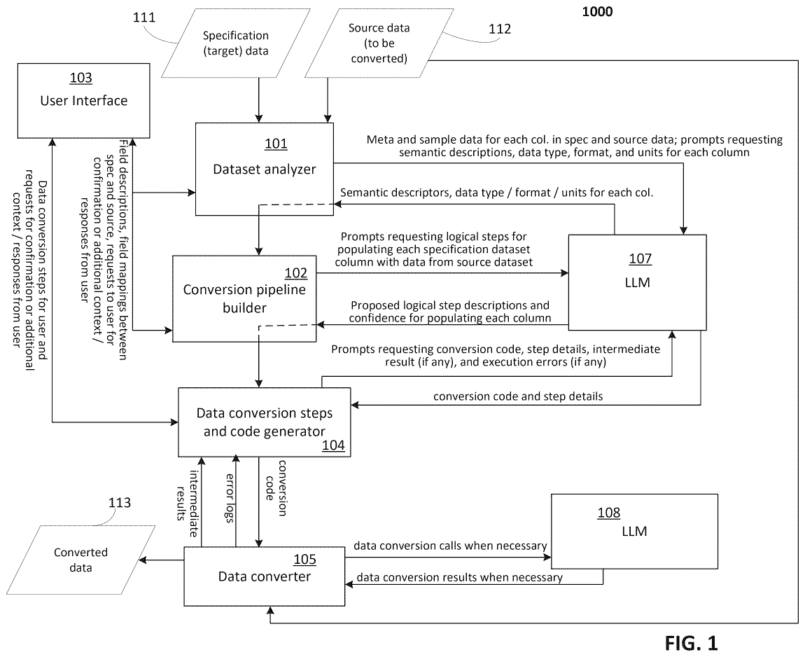

Embodiments of the present disclosure are explained with reference to the accompanying figures. FIG. 1 is a diagram illustrating a data conversion system 1000 in accordance with an embodiment of the present disclosure. System 1000 includes dataset analyzer 101, pipeline builder 102, data conversion steps and code generator 104, data converter 105, computerized large language model (LLM) 107, LLM 108, and user interface 103.

In the illustrated example, dataset analyzer 101 is configured to work with LLM 107 and user interface 103 to assesses the structure and content of both a specification dataset 111 and a source dataset 112. In various embodiments, it facilitates operations such as parsing the datasets and determining metadata, including sample data, and identifying data types and data format. In some embodiments, the determined metadata includes information about data completeness, frequency distributions of values, and statistical summaries of numerical fields.

In the context of data processing systems, it is common to encounter terms such as “column”, “field”, “variable”, and other similar terminology. These terms are often used interchangeably within the technical community and throughout the relevant literature. In the drawings and descriptions provided herein, the term “column” is frequently used. As used herein, “column” refers generally to what is known in data processing arts as a data “field” or “attribute” associated with one or more data values within a dataset, whether or not it is visually presented as a vertical column.

In practical terms, each column can contain multiple rows of data values, aligning with the traditional understanding of how data is visually represented in spreadsheet software or database systems where data is arranged in columns and rows. However, the term “field” is also used interchangeably with “column” or “attribute” in this document to emphasize that the organizational structure of the data can vary. The use of “field” highlights that the data does not need to be displayed or stored in a vertical column format. But data in a same field does represent a logical grouping of data that describes a common characteristic (e.g., “first name” could be considered a “field” or a “column” or an “attribute” which, for a given record, are described by the first name of an individual person). Note that “field” is sometimes used in the art to refer to the individual data values in a column rather than the entire column. However, as used herein, field generally refers to a “container” for the data for a given attribute, e.g., the data in a given column, rather than to the individual data values themselves.

Therefore, whether using the term “column”, “field”, “variable”, “attribute” or other similar terms that one skilled in the art understands as interchangeable in this context, such terms all typically refer to the same fundamental concept of a category for logically grouping/organizing data describing a given attribute of an entity described by the dataset.

In the context of this disclosure, a “specification dataset” refers to a dataset that has a predefined structure and format which serves as a target for data transformation processes. A specification dataset corresponds to a structure which groups the data under various fields, has a certain data type, data format, and/or data units. A “specification dataset,” as used herein, is simply a dataset with a target structure and format and it serves as a blueprint to which the source dataset must conform after conversion.

A “source dataset,” on the other hand, comprises data that is initially in a structure and format that is not necessarily aligned with the specification dataset. In some embodiments, this dataset may come from various data sources and may have inconsistent structures or formats. The primary challenge addressed by system 1000 involves converting the source dataset or datasets into the structure and format of the specification dataset while ensuring data integrity and semantic accuracy.

Pipeline builder 102 utilizes the data descriptions and other information generated or obtained by dataset analyzer 101 along with any additional information received via user interface 103 to work with LLM 107 to try to formulate a pipeline of logical steps which could be implemented by executable code generated by LLM 107 and/or calls to LLM 108 to directly handle certain steps.

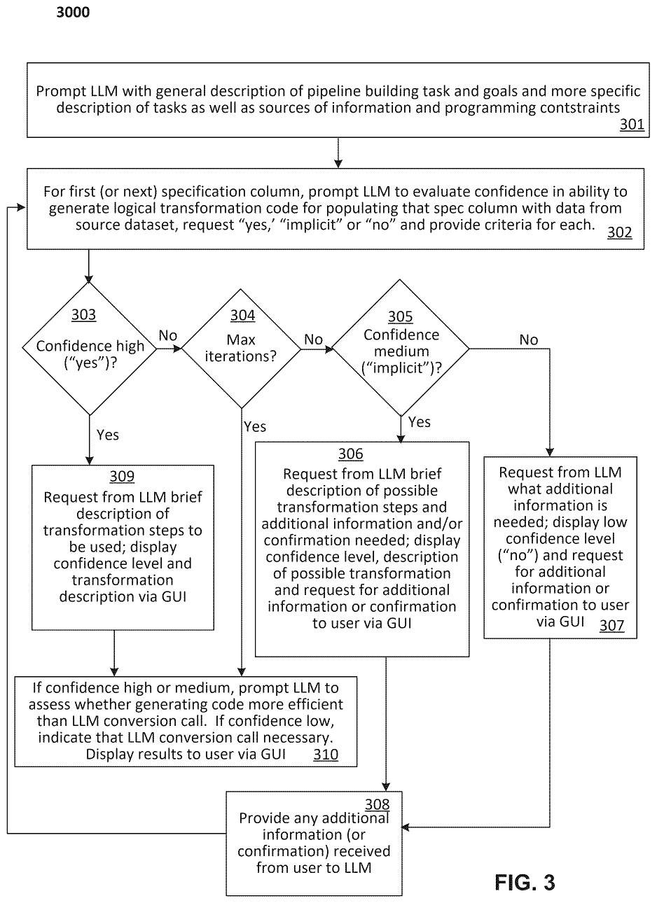

As will be described further in the context of FIG. 3, in some embodiments, pipeline builder 102 interacts with LLM 107 to assess a confidence level for the system being able to generate logical code in one or more selected programming languages. In one example, a selected programming language is Python. In some examples, the confidence level is used to determine whether more information is needed from the user to help LLM 107 better be able to generate logical, executable code for particular steps.

Continuing with the description of FIG. 1, data conversion steps and code generator 104 generates transformation logic in the form of executable code. It translates the transformation steps designed by pipeline builder 102 into code that can be executed to transform the source dataset into the structure and format of the specification dataset.

Data converter 105 executes the transformation code on the source dataset. Data converter 105 ensures that the transformed data adheres to the structure and constraints defined in the specification dataset. In the case of steps for which logical, executable code could not be generated, or in the case of steps for which a user otherwise requests that a direct LLM conversion call be made instead of data conversion code being generated, data converter 105 sends the relevant source data to second LLM 108, along with a prompt to return converted data. Because fulfilling such requests can be resource intensive, they are preferably used sparingly, or when it is clear that executable data conversion code cannot be generated, or cannot be generated efficiently, by LLM 107.

In one embodiment, interface 103 of system 1000 is built using React. In one embodiment, a Python backend is used to run LLM functions and execute all the transformation code. In a particular embodiment, the front end (interface), and backend (execution and data management), are connected via Flask/Socket.IO. In one embodiment, the Python backend uses pandas, and all data transformation codes are generated with respect to pandas DataFrames. In a particular embodiment, LLM 107 is implemented by GPT-40 (gpt-40-2024-05-13) and LLM 108 is implemented by GPT-40-mini. In one embodiment, Guidance is used as the underlying AI framework for assisting with constrained generation and enabling easy switching between different LLMs.

Given the system's use of LLMs, it is preferable to design the system to handle a diverse range of transformation scenarios. Therefore, in an embodiment, prompt design is preferably kept generalized in nature, without specific examples about scenarios. In one embodiment, each of the system's LLM-utilizing operations are created as independent functions with generalized instructions, avoiding specific examples to reduce the risk of biasing the transformations.

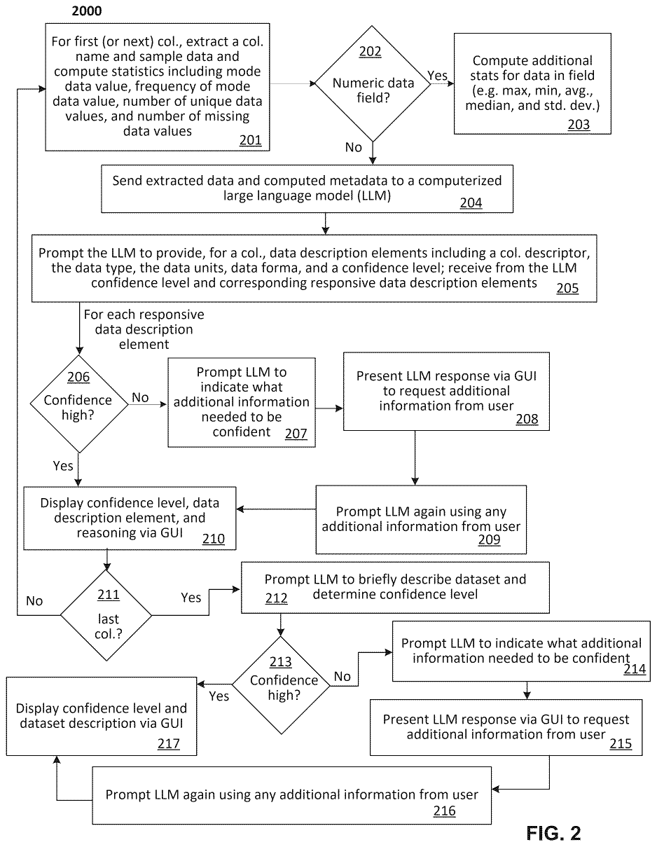

FIG. 2 is a flowchart illustrating a method 2000 for a processing flow that can be implemented by dataset analyzer 101 of FIG. 1, according to an embodiment of the present disclosure. Method 2000 begins at step 201, where, for a first column (field) in a dataset, a column name and sample data are extracted, and statistics are computed. These statistics include the mode data value, frequency of mode data value, number of unique data values, and number of missing data values.

Step 202 then determines whether the data column corresponds to numeric data. If the data column corresponds to numeric data, the flow proceeds to step 203, which computes additional statistics for the data in the column. In a particular embodiment, these statistics include, for example, maximum, minimum, average, median, and standard deviation values for the data in the data column.

If the data field is not numeric, or after the additional numeric statistics are computed, the flow advances to step 204. At step 204, the col. name, sample data from the column, and computed metadata are sent to an LLM (e.g., LLM 107 shown in FIG. 1). The LLM analyzes the column sample data and metadata using advanced AI techniques to generate semantic information about the data.

Step 205 prompts the LLM to provide, for each column, data description elements including a column semantic descriptor (short description), the data type, the data units, the data format, and a confidence level. The LLM's response includes a confidence level indication and corresponding responsive data description elements for each column.

Examples of prompts usable by step 205 to prompt the LLM for, respectively, a column descriptor, a column data type, a column data unit, and a column data format are shown below.

--Give a 1 sentence semantic description/summary of this column -- what
does this data mean, what does it represent? If you don't understand the data,
you should consider asking the user. Be specific, and only use a second
sentence if it is extremely important to represent the description. Write answer
directly, no line breaks required.
--What is the data type of this column (Choose between Number, String,
Boolean, Datetime, or Categorical)? Write answer directly, no line breaks
required.
--What unit is this data represented in (such as scientific units like C, F, KG,
m/s\hat{ }2, N, J, etc., or currency like USD, EUR, etc., or something of that sort)?
If this data is represented in some specific unit, please directly specify the
unit. If not, say N/A. Also, if the data typically is supposed to have a unit but
it's not clear, say N/A, but remember to flag this as an issue when asked for.
Note that not all data needs to conform to a data unit, so first try to understand
what the column represents, and then answer if the data in the column is
reported in a specific unit or not. Write answer directly, no line breaks
required.
--Look at the data samples, do you think the data represented in any specific
format or structure? It could be standardized formats (such as formats for date,
time, etc.) or some semantic structure (such as structures of names, addresses,
etc.). If yes, please directly specify the format/structure. If there's no specific
structure or format, say N/A. Write answer directly, no line breaks required.

A sample prompt usable by step 205 to prompt the LLM for confidence levels corresponding to information responding to above is below.
Before answering the question above, how confident are you in your ability to answer it?
   State your confidence level about your ability to answer the question between “Confident”, “Guessing”, and “Unsure” based on the following criteria:
   1. Confident: Say “Confident” ONLY if you truly understand the semantic meaning behind the data based on the metadata provided above. There is sufficient information available in the provided dataset details to answer the question, or the user has provided sufficient context to answer the question confidently. When you say “Confident”, that means your answer will be grounded in the provided metadata, and you are not making assumptions.
   2. Guessing: Say “Guessing” when you have an answer for the question, but you're making certain assumptions based on your semantic understanding of the data beyond the information provided to you in the metadata provided above. As an expert AI data analysis system, you are expected to at least make an educated guess and provide an intermediate answer based on the provided context even if you're not 100% sure about your answer. Thus, if you're making even a little assumption, but believe that the answer can be improved with more information, you will say that your confidence level is “Guessing”.
   3. Unsure: Consider “Unsure” to be the least preferred option for you to use. You will ONLY say “Unsure” if you think there is not enough information available in the provided metadata to even make an educated guess to answer the given question, and more information is needed to provide a confident answer.
   Please choose your confidence level between Confident, Guessing, or Unsure. Answer in one word, and do not include any other words, punctuation, or symbols in your response. Your next work should be the answer, without any spaces or line breaks.

Step 206, for each responsive data description element, determines whether the confidence level indicated by the LLM is high (e.g., above a threshold). If the confidence is not high, the process moves to step 207 and the LLM is prompted to indicate what additional information is needed to increase confidence in its response.

In step 208, the LLM's response, indicating what additional information needed, is presented via the user interface 103. This allows the user to provide the requested additional information. Step 209 prompts the LLM again, this time using any additional information provided by the user. This iterative process ensures that the data description elements are as accurate and informative as possible.

If the confidence level at step 206 was initially high, or after additional information has been incorporated following steps 207 to 209, the process proceeds to display the confidence level, the data description, and the reasoning via the user interface 103 at step 210.

Step 211 checks if the current column is the last column in the dataset. If it is not the last column, the process loops back to step 201 to analyze the next column. If it is the last column, the process moves to step 212. In step 212, the LLM is prompted to briefly describe the entire dataset and determine the confidence level of this overarching description. A sample prompt for prompting the LLM to describe the entire dataset is shown below.
Provide a 1 sentence description summarizing the entire dataset. In your summary, include what the data means. If you don't understand the data, you should consider asking the user. Be very specific, and only use a second sentence if it is extremely important to represent the description. Write answer directly, no line breaks required.

If the confidence level is not high at step 213, then processing proceeds to step 214 which prompts the LLM to indicate what additional information might be needed to improve the confidence level. The LLM's response is used to query the user via the user interface at step 215. If the user provides additional information, step 216 uses the additional information to prompt the LLM again to re-evaluate the data descriptor and determine if an improved dataset description can be generated and/or if the confidence level is improved. At step 217, the resulting dataset description and corresponding confidence level is displayed via the user interface.

FIG. 3 is a flow chart illustrating a processing flow 3000 that can be executed by the pipeline builder 102 of FIG. 1, according to an embodiment of the present disclosure. The process begins at step 301 by prompting the LLM (e.g., LLM 107 of FIG. 1) with a general description of the pipeline building task and goals, as well as more specific task descriptions, information sources, and programming constraints. An example set of prompts for step 301 are set forth below:

Prompt 1 (for overarching goal):
You were provided with detailed descriptions of the source and specification
datasets.
Your task now is to write Python code that performs transformations on
source datasets to generate entire rows that conform to the structure and
requirements of a target specification dataset.
This process involves row-wise data wrangling from one or more source
datasets into the structure of the specification dataset, ensuring that the
semantic meaning and integrity of the source data are preserved.
The transformation will be broken down into a series of steps, and there may
be intermediate datasets generated during the process which will be used to
generate the final dataset.
Typically, the fields in the specification and source datasets will not match --
your task is to try your best to infer or extract the required information from
the source dataset to generate the fields in the target dataset.
It may happen that the data source does not contain all the information
required to generate every field of the target dataset. In such cases, generate
all the fields that you can while leaving the missing fields empty.
You will be given an opportunity to ask a human-in-the-loop for additional
information to help generate the missing fields.
This is your overarching goal. However, we will break this down into sub-
steps, and you will answer my specific questions as I ask them.
Prompt 2 (providing task specifics):
TASK SPECIFICS:
In this task, you need to specifically build a transformation pipeline for
<specification dataset>.
This will involve you writing a step-by-step transformation code that can
transform the source data to generate fields containing the data for the
columns <specification dataset columns>.
Additionally, there may be previous user-provided information that you can
use to build the transformation pipeline.
For implicit assumptions that user has not provided additional context, you
should follow the implicit assumptions generated previously. But if user has
provided additional context, you should use that to build the transformation
pipeline.
User-Provided Context:
<user provided information>

### Programming Constraints:

When coming up with the transformation logic, you should take into consideration the following constraints:
1. The transformation code should be written in Python.
2. The data will be stored in a pandas DataFrame.

For each specification dataset column, the process, at step 302, prompts the LLM to evaluate its confidence in generating logical transformation code to populate that specification column with data from the source dataset. The LLM is requested to respond with “yes,” “implicit,” or “no” and is provided criteria for each confidence level. An example prompt for use with step 302 is set forth below:

Prompt 3 (to analyze possibility of generating data for each column):
“Is there any kind of logical transformation that can be done to generate data
for the column {column}?
It is highly likely that there's no direct mapping available between the source
and specification datasets -- You need to think in terms of whether there are
any set of transformation operations that can be performed on the source
datasets to generate the data for the required column.
State your confidence level about your ability to generate data for the given
column between ″Yes″, ″Implicit″, and ″No″ based on the following criteria:
1. Yes: Say ″Yes″ if you can perform some kind of transformation/operation
to generate data for this column. If you say ″Yes″, this entails that either (a)
you do not necessarily need any sort of clarification and your generation
strategy is grounded in the data/information that has been provided to you, or
(b) the user has provided the necessary information to answer this question.
2. Implicit: Say ″Implicit″ when you have a probabilistic guess about the
transformation/operation that are needed to be performed to generate the data
for this column. As an expert AI data analysis system, you are expected to at
least make an educated guess and provide some transformation to generate
the data for this column, even if you're not 100% sure about your answer.
When you say ″Implicit″, this entails that you have a workaround to generate
the data for this column, but you will also be given an opportunity to request
additional clarification from the user.
3. No: This should be your least preferred option. You will ONLY say ″No″
if you are absolutely certain that you cannot come up with any programmatic
transformation to generate data for this column. Saying ″No″ means that you
need additional information from the user to generate data for this column.
Please choose your confidence level between ″Yes″, ″Implicit″, or ″No″.
Answer in one word, and do not include any other words, punctuation, or
symbols in your response. Your next work should be the answer, without any
spaces or line breaks.
Choose between: ″Yes″, ″No″, or ″Implicit″.

If the confidence is high (“yes”), as determined at step 303, the process requests a brief description of the transformation steps to be used from the LLM at step 309. The confidence level and transformation description are then displayed via a graphical user interface (GUI).

If the confidence level is not high (result of step 303 is “no”), then step 304 determines whether a pre-determined maximum number of iterations of trying to generate high-confidence steps for that column have occurred. If the result of step 304 is yes, then processing proceeds to step 310.

If the result of step 304 is no, then step 305 determines whether confidence level is medium (“implicit”). If the result of step 305 is yes, then step 306 requests from the LLM a brief description of possible transformation steps and asks the LLM to indicate whether confirmation or any additional information is needed. Step 306 presents to a user, via the GUI (e.g., user interface 103 of FIG. 1), a confidence level, a description of possible transformation steps, and any requests for confirmation received from the LLM. Step 308 provides any additional information (or confirmation) received from the user to the LLM and the process loops back to step 302 to determine if the confidence level and/or the described transformation steps can be improved in view of the additional information.

If the result of step 305 is no (confidence level low), then step 307 requests from the LLM what additional information is needed. Step 307 then presents the low confidence level and request for additional information or confirmation based on the LLM's reply to the user via the GUI.

Step 310, for pipeline steps corresponding to medium or high confidence levels, prompts the LLM to assess whether generating code would be more efficient than an LLM conversion call. For low confidence pipeline steps that have not improved after a maximum number of iterations, step 310 presents to the user via the GUI that an indication that an LLM conversion call will be necessary for that part of the pipeline.

This iterative process continues until all specification columns have been processed. Pipeline builder 102 thus leverages the LLM's capabilities while incorporating user feedback to construct an effective data transformation pipeline.

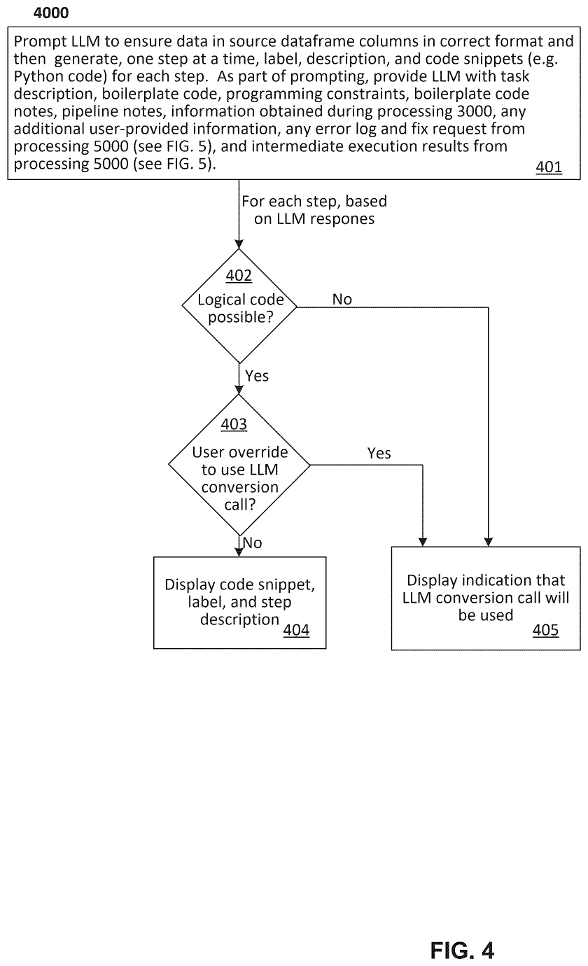

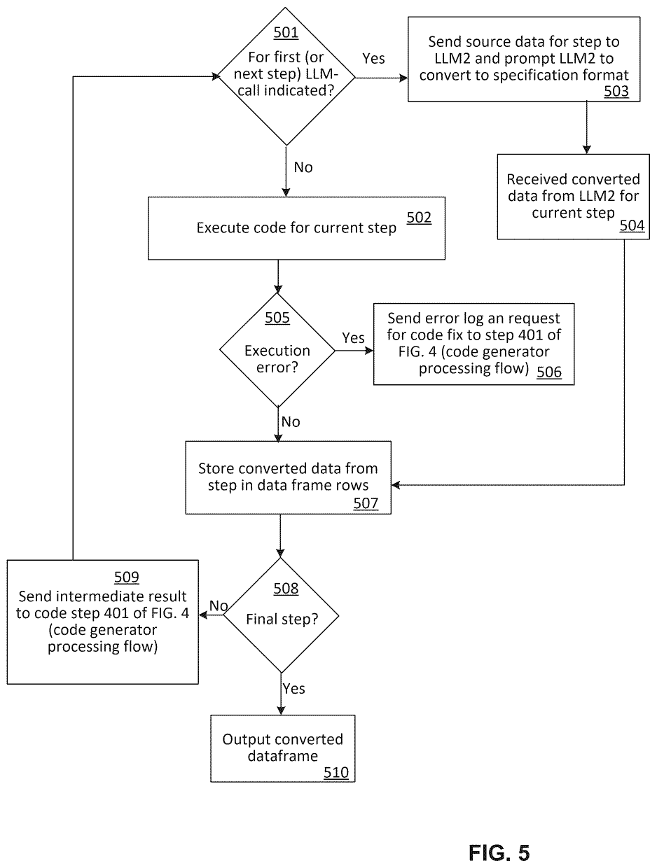

FIG. 4 is a flowchart illustrating an exemplary processing flow 4000 that can be executed by the data conversion steps and code generator 104 of FIG. 1, in accordance with an embodiment of the present disclosure. At step 401, the process prompts the LLM to ensure data in source dataframe columns is in the correct format and then generate, one step at a time, a label, description, and code snippets (e.g., Python code) for each transformation step. As part of the prompting, the process provides the LLM with a task description, boilerplate code, programming constraints, boilerplate code notes, pipeline notes, information obtained during processing 3000, any additional user-provided information, any error log and risk request from processing 5000 (see FIG. 5), and intermediate execution results from processing 5000 (see FIG. 5). Here is one example of initial LLM prompting that can be used by the system at step 401:

TASK SPECIFICS:
In this task, you need to specifically build a transformation pipeline for
<specification dataset>.
This will involve you writing a step-by-step transformation code that can
transform the source data to generate fields containing the data for the
columns <specification dataset columns>.
There may be previously generated assumptions/requirements and user-
provided information that you can use to build the transformation pipeline.
For implicit assumptions that user has not provided additional context, you
should follow the implicit assumptions generated previously. But if user has
provided additional context, you should use that to build the transformation
pipeline.
If there's any field which does not have enough information to generate, you
can leave it empty.
Additionally, you are provided with a boilerplate code that you will use to
build the transformation pipeline:
<boilerplate code here>
BOILERPLATE NOTES:
<boilerplate notes here>
PIPELINE NOTES:
<pipeline notes here>
PROGRAMMING CONSTRAINTS:
When coming up with the transformation logic, you should take into
consideration the following constraints:
1. The transformation code should be written in Python.
2. The data will be stored in a pandas DataFrame.
Lastly, here are some additional information to aid with the data
transformation.
Additional AI-discovered transformation information for each column:
<info from conversion pipeline builder block 102>
Additional User-Provided Information (NOTE: This is some additional
contextual information that the user has provided. Pay extra attention to this
information while building the transformation pipeline):
<user provided information>
You will now be asked to build the transformation pipeline step-by-step.

Regarding the above prompting, here is one example of “boiler plate code” referenced above that can be provided with the prompting. Below assumes the pipeline is built using Python code and that a pandas DataFrame is used is used for storing each relevant dataset (e.g., source dataset, specification dataset, and converted data) (pandas is a Python package). Of course, one skilled in the art would realize that other programming languages could be used for developing appropriate executable code. Python, and the below, are just one example of programming languages and boilerplate code.

```
import pandas as pd
from typing import *
# Other imports
###########################
# STEP FUNCTIONS
###########################
# INPUT: First step function takes original data sources in the form of a
variable “data_sources: Dict[str, pd.DataFrame]”.
    Subsequent step functions use output from previous step function as
input.
# OUTPUT: Each step function MUST return a single Pandas DataFrame
only.
# def step_1_fn(data_sources: Dict[str, pd.DataFrame]) −> pd.DataFrame:
  #1) Load all data sources
  #2) Ensure to combine them into one dataframe combined_df as per below:
  #2a) Stack data sources for the same year column wise (horizontally)
  #2b) Stack data sources for different years row wise (vertically)
  #2c) Add Year column
  #3) To this combined_df, add all the columns from the specification dataset
  #4) Ensure combined_df is not empty. Populate specification dataset
columns with blank values
  # return step_1_fn_output # output will be a single Pandas DataFrame
# def step_2_fn(step_1_fn_output) −> pd.DataFrame:
  # Add transformation for first specification dataset column
  # return step_2_fn_output # output will be a single Pandas DataFrame
# more step functions here
  # Add transformations for the remaining specification dataset columns
# def step_n_fn(step_n-1_fn_output) −> pd.DataFrame:
  # This is final step in the pipeline
  # Keep only specification dataset columns to create output dataframe:
output_df
  # return output_df # output will be a single Pandas DataFrame
###########################
# PIPELINE FUNCTION
###########################
# INPUT: The pipeline function ONLY takes in the original data sources in
the form of a variable “data_sources: Dict[str, pd.DataFrame]” as input.
# OUTPUT: The pipeline function MUST RETURN exact number of
columns as the specification dataset, and the names of the columns MUST
match the specification dataset.
def pipeline(data_sources: Dict[str, pd.DataFrame]) −> pd.DataFrame:
  # Transformation pipeline is executed sequentially
  # step_1_fn_output = step_1_fn(data_sources) # First step takes only data
sources as input
  # step_2_fn_output = step_2_fn(step_1_fn_output) # Subsequent step use
output from previous step as input
  # ...
return output_df
```

On example of prompting language for “<boilerplate notes>” referenced previously in the prompting for step 401 is as follows:
You must stick to the structure provided in the boilerplate code.
Each step will have its own function that will be called in the pipeline function to generate the final dataset.
The names of the functions for each of the steps can be changed, but the pipeline function should be named “pipeline”.
The pipeline function must return in the format specified in the boilerplate code.
No code should be written after the pipeline function.
Only the first step function will be constrained to taking the data_sources as input, but the rest of the steps can take any number of arguments as input as needed.
Finally, assume you have access to the source dataset and its data sources in a Python environment in the following dict format:

```
data_sources = {{ // Dictionary that contains the various data sources as key,
linked to their respective dataframes. Please be sure to replace the
data_source_1_id with the actual data source id obtained from your analysis,
the id's may have filenames, and need to be used verbatim as is
  ‘data_source_1_id’: pd.DataFrame(...),
  ‘data_source_2_id’: pd.DataFrame(...),
  ...
}}
```

One example of prompting language for “<pipeline notes>” referenced previously in the prompting for step 401 is as follows:
Ensure that the pipeline is generated one step at a time. DO NOT GENERATE THE ENTIRE PIPELINE AT ONCE.
At the beginning of the pipeline, ensure that the data in the data sources are in the correct format. Assume that all the columns in the dataframe are in string format by default. Before using any data from the dataframe, you should convert the columns to their appropriate data types.
For each step, you will be asked to generate a label, a description, and a Python code snippet that performs the transformation. When requested for these information, directly provide the information without any additional responses.
DO NOT leave placeholders for any transformation.
Optimize the transformations for performance.
At the end of the pipeline, ensure that:
(a) the generated dataset has the exact number of columns as the specification dataset.
(b) the names of the columns match the specification dataset.
(c) the dataframe does not contain extra columns.
(d) the data represented in each column matches the format specified in the specification dataset.

Based on the LLM response, for each pipeline step, the process determines at step 402 whether logical code is possible for the transformation. If logical code is possible, the process proceeds to step 403 to check if there is a user override to use an LLM conversion call instead. If there is no user override, the process displays the generated code snippet, label, and step description at step 404. If logical code is not possible or if there is a user override, the process displays an indication that an LLM conversion call will be used at step 405.

FIG. 5 is a flowchart illustrating an exemplary processing flow 5000 that can be executed by data converter 105 of FIG. 1, in accordance with an embodiment of the present disclosure. At step 501, the process checks if an LLM call is indicated for the first or next step. If an LLM call is indicated, the process proceeds to step 503 where it sends source data for the conversion step to a second LLM (e.g., LLM 108 in FIG. 1) and prompts it to convert the data to the specification format and return the converted data. At step 504, the process receives the converted data from LLM 108 for the current step.

If an LLM call is not indicated at step 501, the process executes the code for the current step at step 502. An error check occurs at step 505. If an execution error is detected, an error log is sent at step 506, along with requesting a code fix from LLM 107 at step 401 of FIG. 4.

If no execution error occurs, the converted data from the step is stored in DataFrame rows at step 507. At step 508, the process checks if this is the final step. If it is the final step, the process outputs the converted data (in a pandas DataFrame) at step 510. If it is not the final step, then the intermediate results are sent to step 401 of FIG. 4 for further processing at step 509.

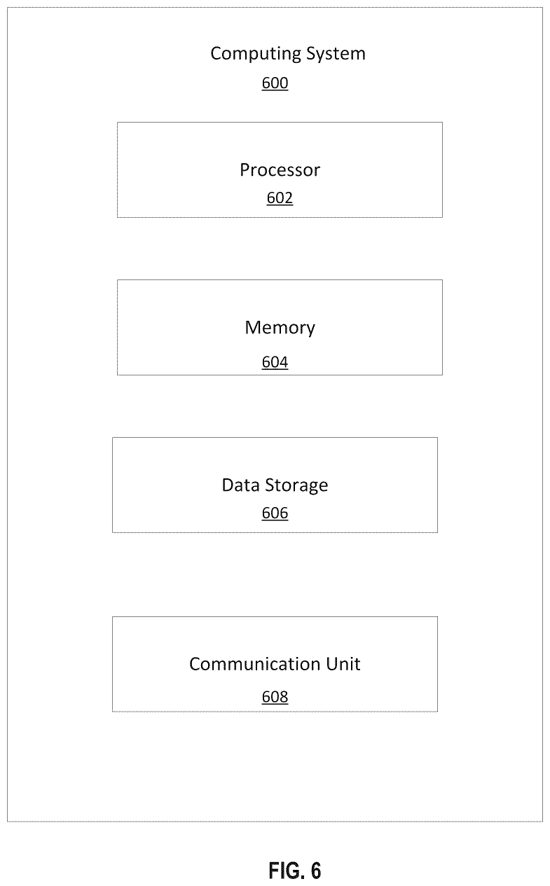

FIG. 6 is an example computing system 600 according to one or more embodiments of the present disclosure. Computing system 600 may include processor 602, memory 604, data storage 606, and/or a communication unit 608, which all may be communicatively coupled. For example, processing system 1000 of FIG. 1 may include one or more components of computing system 600. Moreover, one or more computers carrying out processing described herein may be implemented as one or more computing systems such as computing system 600.

Generally, processor 602 may include any suitable special-purpose or general-purpose computer, computing entity, or processing device including various computer hardware or software modules and may be configured to execute instructions stored on any applicable computer-readable storage media. For example, processor 602 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data.

Although illustrated as a single processor in FIG. 6, it is understood that processor 602 may include any number of processors distributed across any number of network or physical locations that are configured to perform individually or collectively any number of operations described in the present disclosure. In some embodiments, processor 602 may interpret and/or execute program instructions and/or process data stored in memory 604, data storage 606, or memory 604 and data storage 606. In some embodiments, processor 602 may fetch program instructions from data storage 606 and load the program instructions into memory 604.

After the program instructions are loaded into memory 604, processor 602 may execute the program instructions, such as instructions to cause computing system 600 to perform some of the processing operations of method 2000 of FIG. 2, method 3000 of FIG. 3, method 4000 of FIG. 4, and/or method 5000 of FIG. 5.

Memory 604 and data storage 606 may include computer-readable storage media or one or more computer-readable storage mediums for having computer-executable instructions or data structures stored thereon. Such computer-readable storage media may be any available media that may be accessed by a general-purpose or special-purpose computer, such as processor 602. In some embodiments, computing system 600 may or may not include either of memory 604 or data storage 606.

By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to store desired program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause processor 602 to perform a particular operation or group of operations.

Communication unit 608 may include any component, device, system, or combination thereof that is configured to transmit or receive information over a network. In some embodiments, communication unit 608 may communicate with other devices at other locations, the same location, or even other components within the same system. For example, communication unit 608 may include a modem, a network card (wireless or wired), an optical communication device, an infrared communication device, a wireless communication device (such as an antenna), and/or chipset (such as a Bluetooth device, an 802.6 device (e.g., Metropolitan Area Network (MAN)), a WiFi device, a WiMax device, cellular communication facilities, or others), and/or the like. The communication unit 608 may permit data to be exchanged with a network and/or any other devices or systems described in the present disclosure. For example, communication unit 608 may allow computing system 600 to communicate with other systems, such as computing devices and/or other networks.

One skilled in the art, after reviewing this disclosure, may recognize that modifications, additions, or omissions may be made to computing system 600 without departing from the scope of the present disclosure. For example, computing system 600 may include more or fewer components than those explicitly illustrated and described.

Modifications, additions, or omissions may be made to quantum computing system 100 without departing from the scope of the disclosure. The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, it may be recognized that changes may be made in form and detail without departing from the scope of the present disclosure. Thus, the present disclosure is limited only by the claims.

In some embodiments, the different components, modules, engines, and services described herein may be implemented as objects or processes that execute on a computing system (e.g., as separate threads). While some of the systems and methods described herein are generally described as being implemented in software (stored on and/or executed by general purpose hardware), specific hardware implementations or a combination of software and specific hardware implementations are also possible and contemplated.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A method comprising:
receiving a specification dataset and a source dataset;
providing, from one or more computers, for each of a plurality of fields in the specification dataset and the source dataset, a field name and determined metadata, including sample data, to a computerized large language model (LLM);
prompting the LLM to analyze field names and the determined metadata to generate and provide, to the one or more computers, semantic information including data descriptions corresponding to data in fields of the specification dataset and data descriptions corresponding to data in fields of the source dataset;
providing the semantic information to a user interface;
in response to user input received via the user interface, updating the semantic information by one or more of: directly updating the semantic information based on the user input and prompting the LLM to update the semantic information based on the user input; and
prompting the LLM, based on the semantic information and user input received, to generate steps and corresponding step descriptions for converting one or more portions of the source dataset to converted data having a structure and a format of the specification dataset.

2. The method of claim 1, wherein the one or more computers prompt the LLM, for each step of one or more generated steps, to determine a confidence level that the LLM can generate computer-executable code that, if executed by the one or more computers, would successfully implement the step, the method further comprising, by the one or more computers:
receiving from the LLM and presenting, via the user interface, for each step of the one or more generated steps, a step description and a corresponding indication of a determined confidence level of generating computer-executable code to successfully implement the step;
presenting, via the user interface, a request for confirmation or additional information for any step corresponding to a determined confidence level that is below a threshold confidence level; and
providing confirmation or additional information received via the user interface to the LLM.

3. The method of claim 2 wherein the LLM is a first LLM and the user interface is configured to accept a user request to implement a selected step by submitting source data corresponding the selected step to a second LLM with prompting for the second LLM to return converted data in the structure and format of the specification dataset.

4. The method of claim 3, further comprising, by the one or more computers:
prompting the first LLM to, on a step-by-step basis, generate computer-executable code for each step of the steps for which prompting the second LLM is determined not to be necessary and for which no user request has been received for prompting the second LLM; and
presenting the computer executable code via the user interface along with a step label and a step description.

5. The method of claim 4, further comprising, by the one or more computers:
attempting to execute, on a step-by-step basis, the generated computer-executable code for corresponding steps;
for any steps executed successfully, storing resulting converted data; and
for any steps not executed successfully, generating an error log and submitting the error log to the first LLM and prompting the first LLM to attempt to generate code for a corresponding step again in view of the error log.

6. The method of claim 5 further comprising, by the one or more computers:
for any selected steps for which input to the user interface indicates a request for implementation using the second LLM, submitting source data corresponding a selected step to the second LLM with prompting for the second LLM to return converted data in the structure and format of the specification dataset; and
receiving and storing the converted data from the second LLM.

7. The method of claim 1 wherein the determined metadata includes, for each field, data statistics comprising one or more of: a number of missing data elements, a number of unique data elements, a mode data value, and a frequency of the mode data value.

8. The method of claim 7, further comprising,
determining, by the one or more computers, on a field-by-field basis, additional data statistics for data in the specification dataset having a numeric data type; and
providing, by the one or more computers, the additional data statistics to the LLM.

9. The method of claim 8 wherein the additional data statistics comprise one or more of: an average, a median, and a standard deviation.

10. The method of claim 1 further comprising: receiving, by the one or more computers, a confidence level indication from the LLM associated with one or more data descriptions of data description.

11. The method of claim 10, further comprising, by the one or more computers, presenting, via the user interface, a request for confirmation or additional information regarding a data description based on which of a plurality of different confidence levels are associated with the confidence level indication.

12. A system comprising:
a processor;
a memory coupled to the processor;
and
a non-transitory computer-readable storage medium storing instructions that, when executed by the processor, cause the system to implement processing modules comprising:
a dataset analyzer configured to extract, from a specification dataset and a source dataset, metadata, including sample data, and use a computerized large language model (LLM) to analyze the metadata, including sample data, to generate semantic descriptions for the source dataset and of the specification dataset;
a conversion pipeline builder configured to use the LLM to generate a conversion pipeline comprising conversion steps to populate specification dataset fields using data of the source dataset;
a code generator configured to use the LLM to generate, for each conversion step, computer-executable code corresponding to the conversion step;
a data converter configured to execute the computer-executable code to convert the source dataset to a structure and format of the specification dataset; and
a user interface configured to enable user input to modify one or more of: the semantic descriptions, the conversion steps, and the computer-executable code.

13. The system of claim 12, wherein the dataset analyzer is configured to:
extract a field name and sample data for each field in the source dataset and the specification dataset;
compute statistics for data corresponding to each field including a mode data value, frequency of the mode data value, number of unique data values, and number of missing data values; and
for numeric data fields, compute additional statistics including maximum, minimum, average, median, and standard deviation values.

14. The system of claim 13, wherein the dataset analyzer is further configured to:
send extracted data and computed statistics to the LLM;
prompt the LLM to provide, for each field, semantic descriptions including a field descriptor, a data type, data units, and a data format, and a confidence level corresponding to each semantic description; and
receive from the LLM the confidence level and corresponding semantic descriptions.

15. The system of claim 14, wherein the dataset analyzer is further to:
for each responsive data description element, determine if the confidence level is high and if the confidence level is not high, prompt the LLM to indicate what additional information is needed to be confident;
present a response from the LLM via the user interface to request additional information from a user; and
prompt the LLM again using any additional information received from the user.

16. The system of claim 12, wherein the conversion pipeline builder is further configured to, for each field in the specification dataset:
prompt the LLM to evaluate confidence in being able to generate logical conversion code for populating the field with data from the source dataset;
request a confidence level from the LLM selected from at least three levels of confidence; and
provide criteria to the LLM for determining each confidence level.

17. The system of claim 16, wherein the conversion pipeline builder is further configured to:
if the confidence level is not a lowest level of confidence, request from the LLM a description of conversion steps to be used; and
display the confidence level and description of conversion steps via the user interface.

18. The system of claim 16, wherein the conversion pipeline builder is configured to, if the confidence level is a lowest level:
request from the LLM what additional information is needed;
display the confidence level and request for additional information via the user interface; and
if additional information is received via the user interface, provide the additional information to the LLM and request that the LLM re-evaluate being able to generate logical conversion code.

19. The system of claim 16, wherein the code generator is configured to:
prompt the LLM to ensure data to be converted is in a correct format; and
generate, one step at a time, a label, description, and computer-executable code for each step of a data conversion process.

20. A computer program product comprising a non-transitory computer-readable medium storing computer-executable instructions that, when executed by one or more processors, causes the one or more processors to perform processing comprising:
receiving a specification dataset and a source dataset;
providing, for each of a plurality of fields in the specification dataset and the source dataset, a field name and determined metadata, including sample data, to a computerized large language model (LLM);
prompting the LLM to analyze field names and the determined metadata to generate and provide semantic information including data descriptions corresponding to data in fields of the specification dataset and data descriptions corresponding to data in fields of the source dataset;
providing the semantic information to a user interface;
in response to user input received via the user interface, updating the semantic information by one or more of: directly updating the semantic information based on the user input and prompting the LLM to update the semantic information based on the user input; and
prompting the LLM, based on the semantic information and user input received to generate steps and corresponding step descriptions for converting one or more portions of the source dataset to converted data having a structure and a format of the specification dataset.
